(19) United States
(12) Patent Application Publication
(10) Pub. No.: US 2018/0012698 A1
(43) Pub. Date: Jan. 11, 2018

(54) ELECTRONIC COMPONENT

(71) Applicant: MURATA MANUFACTURING CO., LTD., Kyoto-fu (JP)

(72) Inventors: Yoichi NAKATSUJI, Nagaokakyo-shi (JP); Kosuke ISHIDA, Nagaokakyo-shi (JP); Mizuho KATSUTA, Nagaokakyo-shi (JP)

(73) Assignee: MURATA MANUFACTURING CO., LTD., Kyoto-fu (JP)

(21) Appl. No.: 15/612,031

(22) Filed: Jun. 2, 2017

(30) Foreign Application Priority Data
Jul. 6, 2016 (JP) 2016-133797

(51) Int. Cl. H01F 27/28; H01F 27/32; H01F 41/04

(52) U.S. Cl. CPC H01F 27/2804; H01F 41/041; H01F 27/323; H01F 2027/2809

(57) ABSTRACT

An electronic component includes a body, a first inductor, and a low expansion portion. The body includes a laminated body including a plurality of insulating layers laminated in a lamination direction. The insulating layers contain a first resin as a material. The first inductor includes a first inductor conductor layer that adjoins one of the insulating layers. The low expansion portion has a coefficient of linear expansion lower than a coefficient of linear expansion of the plurality of insulating layers. The low expansion portion contains a second resin as a material. At least part of the low expansion portion is embedded in the laminated body. The second resin has a coefficient of linear expansion that is lower than a coefficient of linear expansion of the first resin.

### CROSS REFERENCE TO RELATED APPLICATIONS

This application claims benefit of priority to Japanese Patent Application 2016-133797 filed Jul. 6, 2016, the entire content of which is incorporated herein by reference.

### TECHNICAL FIELD

The present disclosure relates to an electronic component including an inductor.

### BACKGROUND

Examples of an existing disclosure relating to an electronic component include a coil component described in Japanese Unexamined Patent Application Publication No. 2003-133135. FIG. 15 is a sectional view of the structure of a coil component 500 described in Japanese Unexamined Patent Application Publication No. 2003-133135.

As illustrated in FIG. 15, the coil component 500 includes magnetic substrates 501 and 502, a laminated body 510, coils 512 and 513, a magnetic layer 520, and a bonding layer 530. The laminated body 510 is disposed on the upper surface of the magnetic substrate 501. The laminated body 510 is formed by laminating a plurality of insulating layers one on top of another. The coils 512 and 513 each include coil patterns, laminated together with the insulating layers, and a via hole. The coils 512 and 513 are installed in the laminated body 510. Recesses 514 and 515, which vertically extend through the laminated body 510, are formed in the laminated body 510. The magnetic layer 520 is disposed in the recesses 514 and 515 and over the upper surface of the laminated body 510. The bonding layer 530 bonds the upper surface of the magnetic layer 520 and the magnetic substrate 502 together.

### SUMMARY

The coils 512 and 513 in the coil component 500 may be broken in some cases. More specifically, when the coil component 500 is mounted on a circuit board, the coil component 500 is subjected to heat treatment such as reflow soldering. When the coil component 500 is heated, each component in the coil component 500 expands thermally. Here, the coefficient of linear expansion of the coils 512 and 513 is smaller than the coefficient of linear expansion of the laminated body 510 and the coefficient of linear expansion of the magnetic layer 520. In addition, the material of the laminated body 510 and the material of the magnetic layer 520 are a polyimide resin. The coefficient of linear expansion of the laminated body 510 and the coefficient of linear expansion of the magnetic layer 520 thus have a small difference therebetween. Thus, when the coil component 500 is heated, the laminated body 510 and the magnetic layer 520 expand a larger amount per unit volume (the amount is hereinafter simply referred to as an amount of expansion) than an amount of expansion of the coils 512 and 513. Thus, the deformation of the coils 512 and 513 fails to follow the deformation of the laminated body 510 and the magnetic layer 520. This failure to follow the deformation causes tensile stress on the coils 512 and 513, whereby the coils 512 and 513 may be broken at a portion in the coil pattern, at a junction between the coil pattern and the via hole, or at other portions.

Accordingly, the present disclosure aims to provide an electronic component capable of preventing an inductor from causing wire breakage.

An electronic component according to a first aspect of the disclosure includes a body, a first inductor, and a low expansion portion. The body includes a laminated body including a plurality of insulating layers laminated in a lamination direction, the insulating layers containing a first resin as a material. The first inductor includes a first inductor conductor layer that adjoins one of the insulating layers. The low expansion portion has a coefficient of linear expansion lower than a coefficient of linear expansion of the plurality of insulating layers. The low expansion portion contains a second resin as a material and at least part of the low expansion portion is embedded in the laminated body. The second resin has a coefficient of linear expansion that is lower than a coefficient of linear expansion of the first resin.

An electronic component according to a second aspect of the disclosure includes a body, a first inductor, and a low expansion portion. The body includes a laminated body including a plurality of insulating layers laminated in a lamination direction, the insulating layers containing a first resin as a material. The first inductor includes a first inductor conductor layer that adjoins one of the insulating layers. The low expansion portion has a coefficient of linear expansion lower than a coefficient of linear expansion of the plurality of insulating layers. The low expansion portion contains a second resin as a material and at least part of the low expansion portion is embedded in the laminated body. The low expansion portion is non-magnetic.

An electronic component according to a third aspect of the disclosure includes a body and a first inductor. The body includes a laminated body and a first substrate. The laminated body includes a plurality of insulating layers laminated in a lamination direction. The insulating layers contain a resin as a material. The first substrate has a coefficient of linear expansion lower than a coefficient of linear expansion of the plurality of insulating layers. The first substrate adjoins a first main surface of the laminated body. The first main surface is located on a first side in the lamination direction. The first inductor includes a first inductor conductor layer that adjoins one of the insulating layers. The laminated body has a gap portion that adjoins the first substrate.

According to aspects of the present disclosure, inductors are prevented from causing wire breakage.

Other features, elements, characteristics and advantages of the present disclosure will become more apparent from the following detailed description (with reference to the attached drawings).

### BRIEF DESCRIPTION OF THE DRAWINGS

FIG. 1 is an external perspective view of an electronic component.

FIG. 2 is an exploded perspective view of the electronic component illustrated in FIG. 1.

FIG. 3 is a sectional view of the structure of the electronic component illustrated in FIG. 1 taken along line 1-1.

FIG. 4 illustrates a result of a first computer simulation.

FIG. 5 illustrates a model of an electronic component used in a second computer simulation.

FIG. 6 is a graph showing the results of the second computer simulation.

FIG. 7 is a graph showing the results of a third computer simulation.

FIG. 8 is a sectional view of the structure of another electronic component.

FIG. 9 is a graph showing the results of a fourth computer simulation.

FIG. 10 is a graph showing the results of a fifth computer simulation.

FIG. 11 is a perspective view of another electronic component viewed from above.

FIG. 12 is a perspective view of another electronic component viewed from above.

FIG. 13 is a sectional view of the structure of another electronic component.

FIG. 14 is a sectional view of the structure of another electronic component.

FIG. 15 is a sectional view of the structure of a coil component described in Japanese Unexamined Patent Application Publication No. 2003-133135.

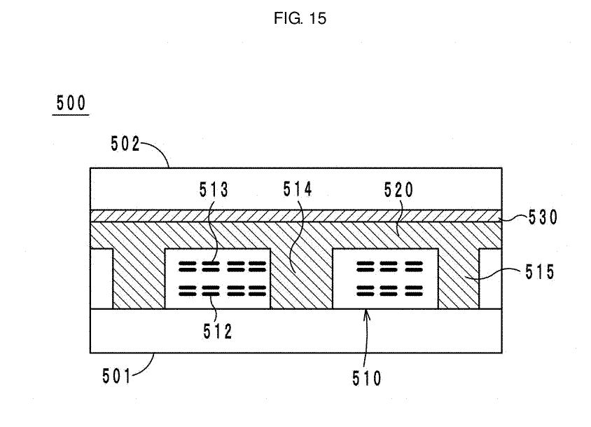

### DETAILED DESCRIPTION

### Configuration of Electronic Component

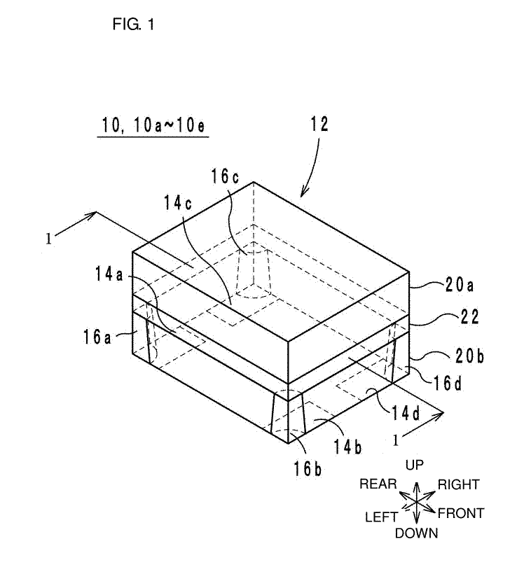

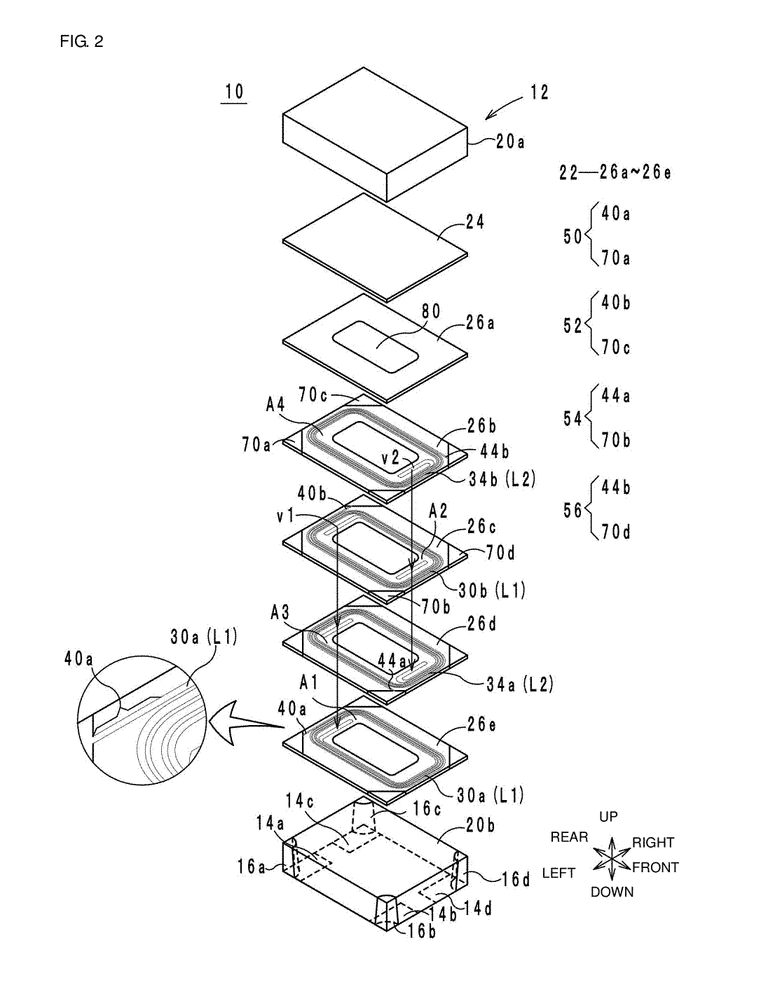

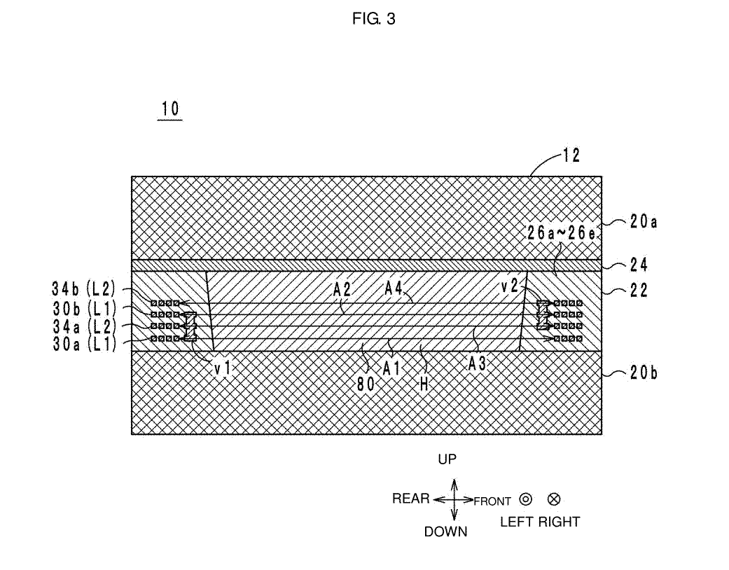

Referring now to the drawings, a configuration of an electronic component 10 according to an embodiment is described first. FIG. 1 is an external perspective view of the electronic component 10. FIG. 2 is an exploded perspective view of the electronic component 10 illustrated in FIG. 1. FIG. 3 is a sectional view of the structure of the electronic component 10 illustrated in FIG. 1 taken along line 1-1. Hereinbelow, a lamination direction of the electronic component 10 is represented as a vertical direction. The direction in which long sides of the electronic component 10 extend when viewed from above is represented as a front-rear direction and the direction in which short sides of the electronic component 10 extend when viewed from above is represented as a lateral direction. The vertical direction, the front-rear direction, and the lateral direction are orthogonal to one another. Here, the lamination direction is a direction in which insulating layers, described below, are laminated one on top of another. The vertical direction, the lateral direction, and the front-rear direction of the electronic component 10 during use may respectively differ from the vertical direction, the lateral direction, and the front-rear direction represented in FIG. 1 or other drawings.

As illustrated in FIG. 1 to FIG. 3, the electronic component 10 includes a body 12, outer electrodes 14a to 14d, connection portions 16a to 16d, exit portions 50, 52, 54 and, 56, a low expansion portion 80, and inductors L1 and L2.

As illustrated in FIG. 1 and FIG. 2, the body 12 forms a rectangular prism shape and includes magnetic substrates 20a and 20b, a laminated body 22, and a bonding layer 24. The magnetic substrate 20a, the bonding layer 24, the laminated body 22, and the magnetic substrate 20b are laminated in this order from top to bottom.

The magnetic substrates 20a and 20b are plate-shaped members each having main surfaces having a rectangular shape when viewed from above. Hereinbelow, the upper main surface of each of the magnetic substrates 20a and 20b is referred to as a top surface and the lower main surface of each of the magnetic substrates 20a and 20b is referred to as an undersurface. The surfaces of each of the magnetic substrates 20a and 20b that connect the top surface and the undersurface are referred to as side surfaces. When viewed from above, the magnetic substrate 20b has four corners that are cut out. More specifically, the magnetic substrate 20b has, at four corners, cuts each having a sector shape having a central angle of 90 degrees when viewed from above. The four cuts vertically extend in the side surfaces of the magnetic substrate 20b from the top surface to the undersurface of the magnetic substrate 20b.

The magnetic substrates 20a and 20b are produced by milling a sintered ferrite ceramic. Alternatively, the magnetic substrates 20a and 20b may be produced by applying, for example, a paste consisting of a ferrite calcination powder and a binder to a ceramic substrate such as alumina or may be produced by laminating and firing green sheets of a ferrite material. The magnetic substrates 20a and 20b have a coefficient X1 of linear expansion. For example, the coefficient X1 of linear expansion falls within the range of approximately 7 to 11 and is approximately 9.5 in this embodiment.

The outer electrodes 14a to 14d are disposed on the undersurface of the magnetic substrate 20b and each have a rectangular shape. More specifically, the outer electrode 14a is disposed at a rear left corner of the undersurface of the magnetic substrate 20b. The outer electrode 14b is disposed at a front left corner of the undersurface of the magnetic substrate 20b. The outer electrode 14c is disposed at a rear right corner of the undersurface of the magnetic substrate 20b. The outer electrode 14d is disposed at a front right corner of the undersurface of the magnetic substrate 20b. The outer electrodes 14a to 14d are produced by depositing a material such as Ag, Ni, Cu, or Ti in a superposing manner by sputtering. Alternatively, the outer electrodes 14a to 14d may be produced by printing and baking a paste containing a metal or by depositing a metal by vapor deposition or plating.

The connection portions 16a to 16d are respectively disposed in the four cuts in the magnetic substrate 20b. The connection portion 16a is disposed in the rear left cut of the magnetic substrate 20b and connected to the outer electrode 14a at its lower end. The connection portion 16b is disposed in the front left cut of the magnetic substrate 20b and connected to the outer electrode 14b at its lower end. The connection portion 16c is disposed in the rear right cut of the magnetic substrate 20b and connected to the outer electrode 14c at its lower end. The connection portion 16d is disposed in the front right cut of the magnetic substrate 20b and connected to the outer electrode 14d at its lower end. The connection portions 16a to 16d are produced by depositing a material such as Ag, Ni, Cu, or Ti in a superposing manner by sputtering. Alternatively, the connection portions 16a to 16d may be produced by printing and baking a paste containing a metal or by depositing a metal by vapor deposition or plating.

The laminated body 22 includes insulating layers 26a to 26e (examples of multiple insulating layers) laminated on the top surface of the magnetic substrate 20b. The laminated body 22 has main surfaces having a rectangular shape when viewed from above. Hereinbelow, the upper main surface of the laminated body 22 is referred to as a top surface (an example of a second main surface located on one side of the laminated body in the lamination direction) and the lower main surface of the laminated body 22 is referred to as an undersurface (an example of a first main surface located on one side of the laminated body in the lamination direction). The laminated body 22 is directly disposed on the top surface of the magnetic substrate 20b. Thus, the magnetic substrate 20b (an example of a first substrate) adjoins the undersurface of the laminated body 22.

The insulating layers 26a to 26e are laminated in this order from top to bottom. The insulating layers 26a to 26e each have substantially the same shape as the top surface of the magnetic substrate 20b. When viewed from above, however, the insulating layers 26b to 26e have cuts at four corners.

The insulating layers 26a to 26e contain an insulating resin (an example of a first resin) as their material. In this embodiment, the insulating layers 26a to 26e are made of polyimide. The insulating layers 26a to 26e are thus non-magnetic. The insulating layers 26a to 26e may be made of, for example, an insulating resin such as benzocyclobutene or an epoxy resin. In the following description, the upper main surface of each of the insulating layers 26a to 26e is referred to as a top surface and the lower main surface of each of the insulating layers 26a to 26e is referred to as an undersurface. The insulating layers 26a to 26e have a coefficient X2 of linear expansion. The coefficient X2 of linear expansion is higher than the coefficient X1 of linear expansion. In other words, the coefficient X1 of linear expansion is lower than the coefficient X2 of linear expansion. Typically, the coefficient of linear expansion of a photosensitive resin is higher than the coefficient of linear expansion of a magnetic substrate. In this embodiment, the coefficient X2 of linear expansion is, for example, approximately 36×10⁻⁶/° C. The insulating resin, which is a material of the insulating layers 26a to 26e, has a coefficient x2 of linear expansion. In this embodiment, the insulating layers 26a to 26e are made purely of the insulating resin. Thus, the coefficient x2 of linear expansion is equal to the coefficient X2 of linear expansion.

The bonding layer 24 flattens the top surface of the laminated body 22 and bonds the magnetic substrate 20a (an example of a second substrate) and the top surface of the laminated body 22 together. The bonding layer 24 is made of, for example, an organic bonding material (such as polyimide). The bonding layer 24 has a coefficient X3 of linear expansion. The coefficient X3 of linear expansion is, for example, higher than or equal to approximately 12×10⁻⁶/° C. and lower than or equal to approximately 36×10⁻⁶/° C. In this embodiment, the coefficient X3 of linear expansion is, for example, approximately 18×10⁻⁶/° C.

The inductor L1 is disposed in the laminated body 22 and includes inductor conductor layers 30a and 30b and an interlayer connection conductor v1. The inductor conductor layer 30a (an example of a first inductor conductor layer) is disposed on the top surface of the insulating layer 26e (an example of a first insulating layer). When viewed from above, the inductor conductor layer 30a forms a substantially spiral shape that winds clockwise (an example of a predetermined direction) from the external side toward the internal side. Thus, the inductor conductor layer 30a adjoins the insulating layers 26d and 26e. When viewed from above, the center of the inductor conductor layer 30a is substantially aligned with the center of the electronic component 10 (point of intersection of diagonal lines).

The inductor conductor layer 30b is disposed on the top surface of the insulating layer 26c. When viewed from above, the inductor conductor layer 30b forms a substantially spiral shape that winds clockwise (an example of a predetermined direction) from the internal side toward the external side. Thus, the inductor conductor layer 30b adjoins the insulating layers 26b and 26c. When viewed from above, the center of the inductor conductor layer 30b is substantially aligned with the center of the electronic component 10 (point of intersection of diagonal lines).

The interlayer connection conductor v1 is a conductor that vertically extends through the insulating layers 26c and 26d and that is disposed on the top surface of the insulating layer 26e. When viewed from above, the interlayer connection conductor v1 forms a laterally extending line. When viewed from above, the interlayer connection conductor v1 is disposed in rear half areas of the insulating layers 26c to 26e. The interlayer connection conductor v1 connects an internal end portion of the inductor conductor layer 30a and an internal end portion of the inductor conductor layer 30b together. Thus, the inductor conductor layer 30a and the inductor conductor layer 30b are electrically connected together in series. The direction in which the inductor conductor layer 30a winds is the same as the direction in which the inductor conductor layer 30b winds. This configuration forms the inductor L1 having turns, the number of which is the sum of the number of turns of the inductor conductor layer 30a and the number of turns of the inductor conductor layer 30b.

The exit portion 50 connects an external end portion of the inductor conductor layer 30a and the outer electrode 14a together. The exit portion 50 includes an exit conductor layer 40a and a connection conductor 70a. The connection conductor 70a is a conductor having a triangular prism shape and disposed at the rear left corners of the insulating layers 26b to 26e. Here, the connection conductor 70a does not have to have a perfect triangular prism shape. Specifically, the connection conductor 70a may have one or more protrusions or one or more depressions on its side surfaces. In FIG. 2, the connection conductor 70a is illustrated in such a manner as to be divided into four sections for ease of understanding. Similarly to the connection conductor 70a, each of connection conductors 70b to 70d is illustrated in such a manner as to be divided into four sections. The connection conductor 70a vertically extends from the top surface of the insulating layers 26b to the undersurface of the insulating layer 26e and is connected to the connection portions 16a at its lower end.

The exit conductor layer 40a is disposed on the top surface of the insulating layer 26e and connects the external end portion of the inductor conductor layer 30a and the connection conductor 70a together. When viewed from above, the exit conductor layer 40a does not form a substantially spiral shape and extends leftward from the external end portion of the inductor conductor layer 30a. As illustrated in an enlarged view of FIG. 2, the boundary between the inductor conductor layer 30a and the exit conductor layer 40a is located at a position at which the exit conductor layer 40a deviates from the substantially spiral track formed by the inductor conductor layer 30a. Thus, the external end portion of the inductor conductor layer 30a and the outer electrode 14a are connected together with the exit portion 50 (exit conductor layer 40a and connection conductor 70a) and the connection portion 16a interposed therebetween.

The exit portion 52 connects the external end portion of the inductor conductor layer 30b and the outer electrode 14c together. The exit portion 52 includes an exit conductor layer 40b and a connection conductor 70c. The connection conductor 70c is a conductor having a triangular prism shape and disposed at the rear right corners of the insulating layers 26b to 26e. The connection conductor 70c vertically extends from the top surface of the insulating layer 26b to the undersurface of the insulating layer 26e and is connected to the connection portion 16c at its lower end.

The exit conductor layer 40b is disposed on the top surface of the insulating layer 26c and connects the external end portion of the inductor conductor layer 30b and the connection conductor 70c together. When viewed from above, the exit conductor layer 40b does not form a substantially spiral shape and extends rightward from the external end portion of the inductor conductor layer 30b. The boundary between the inductor conductor layer 30b and the exit conductor layer 40b is located at a position at which the exit conductor layer 40b deviates from the substantially spiral track formed by the inductor conductor layer 30b. Thus, the external end portion of the inductor conductor layer 30b and the outer electrode 14c are connected together with the exit portion 52 (exit conductor layer 40b and connection conductor 70c) and the connection portion 16c interposed therebetween.

When viewed from above, the area surrounded by the inductor L2 overlaps the area surrounded by the inductor L1. The inductor L2 is thus magnetically coupled with the inductor L1. The inductor L2 is disposed in the laminated body 22 and includes inductor conductor layers 34a and 34b and an interlayer connection conductor v2. The inductor conductor layer 34a (an example of a second inductor conductor layer) is disposed on the top surface of the insulating layers 26d (an example of a second insulating layer). When viewed from above, the inductor conductor layer 34a forms a substantially spiral shape that winds clockwise (an example of a predetermined direction) from the external side toward the internal side. Thus, the inductor conductor layer 34a adjoins the insulating layers 26c and 26d. When viewed from above, the center of the inductor conductor layer 34a is substantially aligned with the center of the electronic component 10 (point of intersection of diagonal lines).

The inductor conductor layer 34b is disposed on the top surface of the insulating layer 26b. When viewed from above, the inductor conductor layer 34b forms a substantially spiral shape that winds clockwise (an example of a predetermined direction) from the internal side toward the external side. Thus, the inductor conductor layer 34b adjoins the insulating layers 26a and 26b. When viewed from above, the center of the inductor conductor layer 34b is substantially aligned with the center of the electronic component 10 (point of intersection of diagonal lines).

The interlayer connection conductor v2 is a conductor that vertically extends through the insulating layers 26b and 26c and that is disposed on the top surface of the insulating layers 26d. When viewed from above, the interlayer connection conductor v2 forms a laterally extending line. When viewed from above, the interlayer connection conductor v2 is disposed in front half areas of the insulating layers 26b to 26d. The interlayer connection conductor v2 connects an internal end portion of the inductor conductor layer 34a and an internal end portion of the inductor conductor layer 34b together. Thus, the inductor conductor layer 34a and the inductor conductor layer 34b are electrically connected together in series. The direction in which the inductor conductor layer 34a winds is the same as the direction in which the inductor conductor layer 34b winds. This configuration forms the inductor L2 having turns, the number of which is the sum of the number of turns of the inductor conductor layer 34a and the number of turns of the inductor conductor layer 34b.

The exit portion 54 connects an external end portion of the inductor conductor layer 34a and the outer electrode 14b together. The exit portion 54 includes an exit conductor layer 44a and a connection conductor 70b. The connection conductor 70b is a conductor having a triangular prism shape and disposed at the front left corners of the insulating layers 26b to 26e. The connection conductor 70b vertically extends from the top surface of the insulating layers 26b to the undersurface of the insulating layer 26e and is connected to the connection portions 16b at its lower end.

The exit conductor layer 44a is disposed on the top surface of the insulating layer 26d and connects the external end portion of the inductor conductor layer 34a and the connection conductor 70b together. When viewed from above, the exit conductor layer 44a does not form a substantially spiral shape and extends frontward from the external end portion of the inductor conductor layer 34a. The boundary between the inductor conductor layer 34a and the exit conductor layer 44a is located at a position at which the exit conductor layer 44a deviates from the substantially spiral track formed by the inductor conductor layer 34a. Thus, the external end portion of the inductor conductor layer 34a and the outer electrode 14b are connected together with the exit portion 54 (exit conductor layer 44a and connection conductor 70b) and the connection portion 16b interposed therebetween.

The exit portion 56 connects an external end portion of the inductor conductor layer 34b and the outer electrode 14d together. The exit portion 56 includes an exit conductor layer 44b and a connection conductor 70d. The connection conductor 70d is a conductor having a triangular prism shape and disposed at the front right corners of the insulating layers 26b to 26e. The connection conductor 70d vertically extends from the top surface of the insulating layers 26b to the undersurface of the insulating layer 26e and is connected to the connection portions 16d at its lower end.

The exit conductor layer 44b is disposed on the top surface of the insulating layer 26b and connects the external end portion of the inductor conductor layer 34b and the connection conductor 70d together. When viewed from above, the exit conductor layer 44b does not form a substantially spiral shape and extends frontward from the external end portion of the inductor conductor layer 34b. The boundary between the inductor conductor layer 34b and the exit conductor layer 44b is located at a position at which the exit conductor layer 44b deviates from the substantially spiral track formed by the inductor conductor layer 34b. Thus, the external end portion of the inductor conductor layer 34b and the outer electrode 14d are connected together with the exit portion 56 (exit conductor layer 44b and connection conductor 70d) and the connection portion 16d interposed therebetween.

The inductor conductor layers 30a, 30b, 34a, and 34b, the exit conductor layers 40a, 40b, 44a, and 44b, the connection conductors 70a to 70d, and the interlayer connection conductors v1 and v2 are produced by depositing a material such as Ag, Ni, Cu, or Ti in a superposing manner by sputtering. Alternatively, the inductor conductor layers 30a, 30b, 34a, and 34b, the exit conductor layers 40a, 40b, 44a, and 44b, the connection conductors 70a to 70d, and the interlayer connection conductors v1 and v2 may be produced by printing and baking a paste containing a metal or by depositing a metal by vapor deposition or plating. The inductor conductor layers 30a, 30b, 34a, and 34b, the exit conductor layers 40a, 40b, 44a, and 44b, the connection conductors 70a to 70d, and the interlayer connection conductors v1 and v2 have a coefficient X4 of linear expansion. The coefficient X4 of linear expansion is lower than the coefficient X2 of linear expansion. The coefficient of linear expansion of Ag is approximately 18.9×10⁻⁶/° C., the coefficient of linear expansion of Cu is approximately 16.5×10⁻⁶/° C., and the coefficient of linear expansion of Au is approximately 14.2×10⁻⁶/° C.

The low expansion portion 80 forms a rectangular prism shape that extends vertically and at least part of the low expansion portion 80 is embedded in the laminated body 22. In FIG. 2, the low expansion portion 80 is illustrated in such a manner as to be divided into five sections for ease of understanding. In this embodiment, as illustrated in FIG. 3, the laminated body 22 has a through hole H, which vertically extends through the laminated body 22. When viewed from above, the through hole H is located in the areas surrounded by the inductors L1 and L2. More specifically, the through hole H vertically extends through areas A1 to A4 respectively surrounded by the inductor conductor layers 30a, 30b, 34a, and 34b. The low expansion portion 80 is disposed in the through hole H. Thus, the low expansion portion 80 is located in the areas A1 to A4. The top surface and the undersurface of the low expansion portion 80 are exposed through the top surface and the undersurface of the laminated body 22. The low expansion portion 80, however, adjoins the magnetic substrate 20b at the lower end of the through hole H (an end portion on one side of the laminated body in the lamination direction) and adjoins the bonding layer 24 at the upper end of the through hole H (an end portion on the other side of the laminated body in the lamination direction). Thus, the low expansion portion 80 is not exposed through the body 12.

As described above, the state where at least part of the low expansion portion 80 is embedded in the laminated body 22 represents that at least part of the low expansion portion 80 is disposed in the laminated body 22. In other words, the configuration in which at least part of the low expansion portion 80 is embedded in the laminated body 22 does not include the configuration in which a resin is applied to the surface of the laminated body 22. Specifically, the low expansion portion 80 is different from the bonding layer 24. In this embodiment, the entirety of the low expansion portion 80 is located in the laminated body 22 and the top surface and the undersurface of the low expansion portion 80 are exposed through the laminated body 22. Alternatively, the low expansion portion 80 may protrude beyond the top surface of the laminated body 22. Instead, the low expansion portion 80 does not have to be exposed through the laminated body 22.

When viewed from above, the low expansion portion 80 forms a rectangular shape having long sides extending in the front-rear direction and short sides extending in the lateral direction. When viewed from above, the interlayer connection conductor v1 extends along the rear short side of the low expansion portion 80. When viewed from above, the interlayer connection conductor v2 extends along the front short side of the low expansion portion 80.

The low expansion portion 80 contains an insulating resin (an example of a second resin) as a material. In this embodiment, the insulating resin is formed by mixing a silica filler into a non-photosensitive polyimide resin. The content of the silica filler is approximately 57% by volume of the low expansion portion 80. Thus, the low expansion portion 80 is non-magnetic. The low expansion portion 80 has a coefficient X5 of linear expansion. The coefficient X5 of linear expansion is lower than the coefficient X2 of linear expansion. The coefficient X5 of linear expansion is, for example, higher than or equal to approximately 12×10⁻⁶/° C. and lower than or equal to approximately 30×10⁻⁶/° C. In this embodiment, the coefficient X5 of linear expansion is, for example, approximately 12×10⁻⁶/° C. The insulating resin, which is a material of the low expansion portion 80, has a coefficient x5 of linear expansion. The coefficient x5 of linear expansion is lower than the coefficient x2 of linear expansion. The insulating resin is a non-photosensitive polyimide resin and thus the coefficient x5 of linear expansion is approximately 18×10⁻⁶/° C. The coefficient X5 of linear expansion of the low expansion portion 80 is thus rendered lower than the coefficient x5 of linear expansion of the insulating resin due to mixing of the silica filler into the non-photosensitive polyimide resin.

The operation of the electronic component 10 having the above-described configuration is described below. The outer electrodes 14a and 14b are used as input terminals. The outer electrodes 14c and 14d are used as output terminals.

Differential transmission signals are input to the outer electrodes 14a and 14b and output from the outer electrodes 14c and 14d. When a normal mode signal in the differential transmission signals flows through the inductors L1 and L2, the inductors L1 and L2 produce magnetic fluxes in opposite directions in response to the normal mode signal. The magnetic fluxes thus cancel each other, so that impedance is less likely to be presented to the current of the normal mode signal. When, on the other hand, the differential transmission signals include a common mode noise, the inductors L1 and L2 produce magnetic fluxes in the same direction in response to the current of the common mode noise. Thus, the magnetic fluxes enhance each other so that impedance is presented to the current of the common mode noise. As a result, the current of the common mode noise is converted into heat and hindered from passing through the inductors L1 and L2. In this manner, the inductor L1 and the inductor L2 form a common mode choke coil as a result of being magnetically coupled with each other.

### Method for Manufacturing Electronic Component

A method for manufacturing the electronic component 10 is described below. A case where one electronic component 10 is manufactured is described below as an example. Actually, however, multiple electronic components 10 are concurrently formed as a result of laminating large mother magnetic substrates and mother insulating layers together to form a mother body and cutting the mother body into pieces.

Firstly, a polyimide resin, which is a photosensitive resin, is applied to the entirety of the top surface of the magnetic substrate 20b. Subsequently, the polyimide resin is exposed to light while portions corresponding to the four corners of the insulating layer 26e are shielded from light. Thus, the polyimide resin at the portion that has not been shielded from light is cured. Thereafter, an uncured polyimide resin is removed by an organic solvent in a developing process and the polyimide resin is subjected to thermosetting. Thus, the insulating layer 26e is formed.

Subsequently, a Cu film is deposited by sputtering on the insulating layer 26e and the magnetic substrate 20b exposed through the insulating layer 26e. Then, a photoresist is disposed at portions at which the inductor conductor layer 30a, the exit conductor layer 40a, the connection conductors 70a to 70d, and the interlayer connection conductor v1 are to be formed. Then, a Ag film is removed by etching at the portion other than the portions (that is, the portions covered with the photoresist) at which the inductor conductor layer 30a, the exit conductor layer 40a, the connection conductors 70a to 70d, and the interlayer connection conductor v1 are to be formed. The photoresist is then removed by the organic solvent, so that the inductor conductor layer 30a, the exit conductor layer 40a, part of the connection conductors 70a to 70d (corresponding to one layer), and part of the interlayer connection conductor v1 are formed.

The step similar to the above-described step is repeated to form the insulating layers 26a to 26d, the inductor conductor layers 30b, 34a, and 34b, the exit conductor layers 40a, 44a, and 44b, the remaining portions of the connection conductors 70a to 70d, the remaining portion of the interlayer connection conductor v1, and the interlayer connection conductor v2.

Subsequently, a resist that covers a portion of the insulating layers 26a other than the portion at which the low expansion portion 80 is to be formed is disposed on the top surface of the insulating layers 26a. Then, a through hole H that vertically extends through the insulating layers 26a to 26e is formed by sandblasting using the resist as a mask. The resist is then removed by an organic solvent. Here, the through hole H may be formed by laser processing, by a combination of sandblasting and laser processing, or by etching.

The through hole H is then filled, by screen printing, with a resin into which a silica filler is mixed. The resin into which a silica filler is mixed is to form the low expansion portion 80. The resin is, for example, a non-photosensitive polyimide resin and has a low coefficient of linear expansion.

Then, a resin that is to form the bonding layer 24 is applied to the surface of the laminated body 22 and the magnetic substrate 20a is then fixed onto the bonding layer 24 by heat treatment and pressing treatment.

Subsequently, four cuts are formed in the magnetic substrate 20b by sandblasting. Instead of sandblasting, the cuts may be formed by laser processing or by a combination of sandblasting and laser processing.

Finally, conductor layers are formed on the inner surfaces of the cuts of the magnetic substrate 20b by a combination of electroplating and photolithography to form the connection portions 16a to 16d and the outer electrodes 14a to 14d.

### Effects

Firstly, the relationship between the coefficients X1 to X5, x2, and x5 of linear expansion of the portions of the electronic component 10 is clarified.

(1) The coefficient X4 of linear expansion of the inductor conductor layers 30a, 30b, 34a, and 34b, the exit conductor layers 40a, 40b, 44a, and 44b, and the connection conductors 70a to 70d is lower than the coefficient X2 of linear expansion of the insulating layers 26a to 26e.

(2) The coefficient X5 of linear expansion of the low expansion portion 80 is lower than the coefficient X2 of linear expansion of the insulating layers 26a to 26e.

(3) The coefficient x5 of linear expansion of the insulating resin from which the low expansion portion 80 is made is lower than the coefficient x2 of linear expansion of the insulating resin from which the insulating layers 26a to 26e are made.

(4) The coefficient X1 of linear expansion of the magnetic substrates 20a and 20b is lower than the coefficient X2 of linear expansion of the insulating layers 26a to 26e.

(5) The coefficient X5 of linear expansion of the low expansion portion 80 is lower than the coefficient X3 of linear expansion of the bonding layer 24.

The electronic component 10 according to this embodiment is capable of preventing the inductors L1 and L2 from causing wire breakage. More specifically, the coefficient X4 of linear expansion of the inductors L1 and L2 (inductor conductor layers 30a, 30b, 34a, and 34 and interlayer connection conductors v1 and v2) is lower than the coefficient X2 of linear expansion of the insulating layers 26a to 26e. Thus, when the electronic component 10 is heated, the insulating layers 26a to 26e expand to a larger extent than the extent to which the inductors L1 and L2 expand. Thus, tensile stress is exerted on the inductors L1 and L2. Such tensile stress causes wire breakage or partial wire breakage of the inductors L1 and L2, which results in a conductivity reduction.

Thus, the electronic component 10 includes the low expansion portion 80, at least part of which is embedded in the laminated body 22. The coefficient x5 of linear expansion of the insulating resin from which the low expansion portion 80 is made is lower than the coefficient x2 of linear expansion of the insulating resin of the insulating layers 26a to 26e. Moreover, the low expansion portion 80 is made of a material in which a silica filler is mixed in the insulating resin. Thus, the coefficient X5 of linear expansion of the low expansion portion 80 is lower than the coefficient x5 of linear expansion of the insulating resin. The coefficient X5 of linear expansion of the low expansion portion 80 is thus significantly lower than the coefficient X2 of linear expansion of the insulating layers 26a to 26e. Thus, when the electronic component 10 is heated, the low expansion portion 80 expands to a smaller extent than the extent to which the insulating layers 26a to 26e expand. The stress caused by the expansion of the insulating layers 26a to 26e is thus likely to be discharged toward the low expansion portion 80. In this manner, the tensile stress exerted on the inductors L1 and L2 decreases, so that an occurrence of wire breakage in the inductors L1 and L2 is prevented.

The insulating layers 26a to 26e in the electronic component 10 are formed by photolithography. Thus, the insulating layers 26a to 26e are made of a resin suitable for photolithography. Such a resin is limited to resins having a relatively large coefficient of linear expansion. On the other hand, the low expansion portion 80 is formed by filling the through hole H with a resin. Thus, the resin usable for the low expansion portion 80 is selectable from a wider choice of options than the choice of options from which the resin usable for the insulating layers 26a to 26e is selected. Thus, a resin having the coefficient x5 of linear expansion, which is relatively small, is usable for the low expansion portion 80.

The electronic component 10 is capable of effectively preventing an occurrence of wire breakage in the inductors L1 and L2 also due to the following reasons. More specifically, in the electronic component 10, the presence of the low expansion portion 80 is capable of effectively preventing portions of the insulating layers 26a to 26e located adjacent to the low expansion portion 80 from expanding further than portions of the insulating layers 26a to 26e located further away from the low expansion portion 80. Thus, in view of preventing an occurrence of wire breakage of the inductors L1 and L2, it is preferable that the inductors L1 and L2 be located adjacent to the low expansion portion 80.

Thus, the inductor conductor layers 30a, 30b, 34a, and 34b each form a substantially spiral shape that winds clockwise, when viewed from above. In addition, the low expansion portion 80 is located in the areas surrounded by the inductors L1 and L2, when viewed from above. Specifically, a large part of the inductor conductor layers 30a, 30b, 34a, and 34b is located adjacent to the low expansion portion 80. This configuration thus more effectively prevents an occurrence of wire breakage in the inductors L1 and L2.

The electronic component 10 effectively prevents an occurrence of wire breakage at connection portions between the interlayer connection conductor v1 and the inductor conductor layers 30a and 30b and at connection portions between the interlayer connection conductor v2 and the inductor conductor layers 34a and 34b. More specifically, wire breakage is more likely to occur at connection portions between the interlayer connection conductor v1 and the inductor conductor layers 30a and 30b and at connection portions between the interlayer connection conductor v2 and the inductor conductor layers 34a and 34b. Thus, the low expansion portion 80 in the electronic component 10 is located within the areas surrounded by the inductors L1 and L2, when viewed from above. The interlayer connection conductors v1 and v2 are located adjacent to the areas surrounded by the inductors L1 and L2, when viewed from above. Thus, the low expansion portion 80 is located adjacent to the interlayer connection conductors v1 and v2. This configuration thus reduces tensile stress exerted on the connection portions between the interlayer connection conductor v1 and the inductor conductor layers 30a and 30b and the connection portions between the interlayer connection conductor v2 and the inductor conductor layers 34a and 34b. Consequently, an occurrence of wire breakage at these connection portions is prevented.

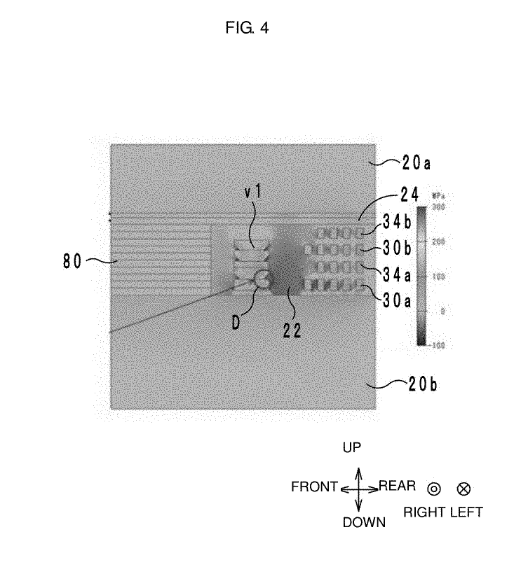

The inventors of the application conducted a first computer simulation, described below, to clarify the effects of the electronic component 10. More specifically, the inventors of the application created a first model having the same structure as that of the electronic component 10. The temperature of the first model was raised from 25° C. to 270° C. and the tensile stress that occurred at each portion of the first model was calculated by a computer. FIG. 4 illustrates a result of a first computer simulation. In FIG. 4, stress that occurs at each portion of the first model is originally illustrated with colors. FIG. 4 substantially coincides with the sectional view of the structure in FIG. 3. FIG. 4, however, is a sectional view of the structure of the electronic component 10 viewed from the right, whereas FIG. 3 is a sectional view of the structure of the electronic component 10 viewed from the left. In addition, the number of turns of each of the inductors L1 and L2 differs between FIG. 3 and FIG. 4 since the position of the section slightly differs between FIG. 3 and FIG. 4.

The simulation conditions of the first computer simulation are described below.

The coefficient X1 of linear expansion is approximately 9.5×10⁻⁶/° C.

The coefficient X2 of linear expansion is approximately 36×10⁻⁶/° C.

The coefficient X3 of linear expansion is approximately 18×10⁻⁶/° C.

The coefficient X4 of linear expansion is approximately 16.5×10⁻⁶/° C.

The coefficient X5 of linear expansion is approximately 12×10⁻⁶/° C.

FIG. 4 is originally formed as a color diagram but actually illustrated in black and white. In FIG. 4, a portion at which a stress of −100 MPa occurs is originally illustrated in dark blue. A portion at which a stress of 0 MPa occurs is originally illustrated in light blue. A portion at which a stress of 100 MPa occurs is originally illustrated in yellow green. A portion at which a stress of 200 MPa occurs is originally illustrated in yellow. A portion at which a stress of 300 MPa occurs is originally illustrated in red. FIG. 4 shows that a red portion form near the center of a portion enclosed with circle D and has the largest stress. The portion enclosed with circle D is a portion located in front of and near the lower end of the interlayer connection conductor v1. Specifically, the first computer simulation shows that wire breakage is particularly more likely to occur in the inductors L1 and L2 at a portion located in front of and near the lower end of the interlayer connection conductor v1.

Instead of the hard magnetic substrate 20a, the soft bonding layer 24 is disposed over the interlayer connection conductor v1. Thus, the stress in the insulating layer 26a is likely to be discharged to the bonding layer 24. Thus, a large tensile stress is less likely to occur near the upper end of the interlayer connection conductor v1.

In addition, the low expansion portion 80 is disposed in front of the interlayer connection conductor v2. This configuration prevents the insulating layers 26b to 26d, located in front of the interlayer connection conductor v2, from expanding to a large extent when the electronic component 10 is heated. Thus, a large tensile stress is less likely to occur at a portion in front of the interlayer connection conductor v2.

The volume of the portions of the insulating layers 26a to 26e located at the back of the interlayer connection conductor v1 is larger than the volume of the portions of the insulating layers 26a to 26e located in front of the interlayer connection conductor v1. Thus, the difference in amount of expansion between the insulating layers 26a to 26e and the portion located at the back of and near the lower end of the interlayer connection conductor v1 is larger than the difference in amount of expansion between the insulating layers 26a to 26e and the portion located in front of and near the upper end of the interlayer connection conductor v1. Thus, a large tensile stress is more likely to occur at the portion located at the back of and near the lower end of the interlayer connection conductor v2. Probably because of the above-described reason, wire breakage is particularly more likely to occur in the inductors L1 and L2 at a portion located at the back of and near the lower end of the interlayer connection conductor v2.

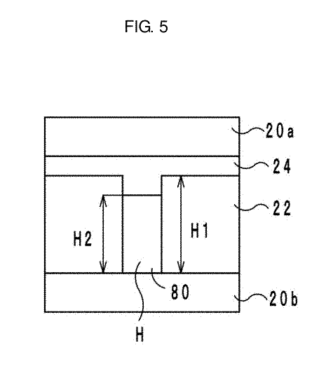

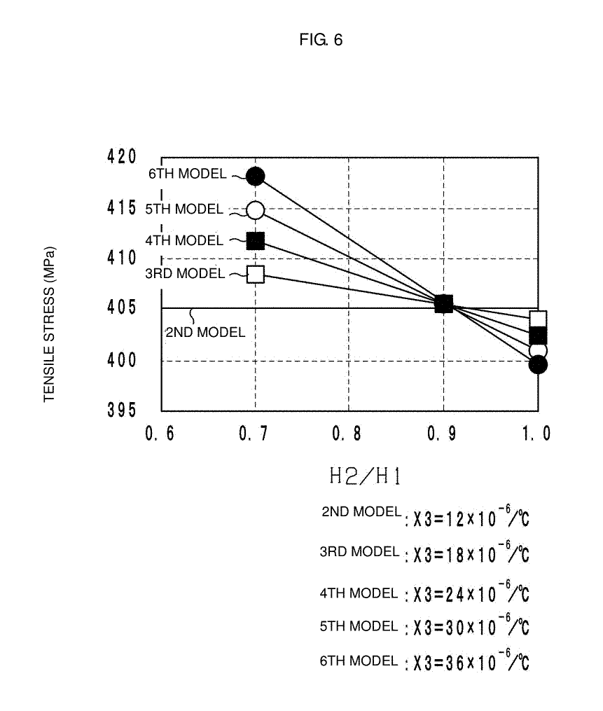

Subsequently, the inventors of the application conducted a second computer simulation. FIG. 5 shows a model used in the second computer simulation. In the second computer simulation, the inventors of the application created the model illustrated in FIG. 5. In the model illustrated in FIG. 5, the bonding layer 24 enters the through hole H. In the model illustrated in FIG. 5, the height of the laminated body 22 is defined as a height H1 and the height of the low expansion portion 80 in the vertical direction is defined as a height H2. The inventors of the application created a second model to a sixth model, each having the structure of the model illustrated in FIG. 5. The coefficient X3 of linear expansion of the bonding layer 24 of the second model is approximately 12×10⁻⁶/° C. The coefficient X3 of linear expansion of the bonding layer 24 of the third model is approximately 18×10⁻⁶/° C. The coefficient X3 of linear expansion of the bonding layer 24 of the fourth model is approximately 24×10⁻⁶/° C. The coefficient X3 of linear expansion of the bonding layer 24 of the fifth model is approximately 30×10⁻⁶/° C. The coefficient X3 of linear expansion of the bonding layer 24 of the sixth model is approximately 36×10⁻⁶/° C. The coefficients X1, X2, X4, and X5 of linear expansion are the same as those used in the first computer simulation. The inventors of the application caused the computer to calculate the tensile stress while H2/H1 in each of the second model to the sixth model was changed. The calculated tensile stress is the maximum tensile stress caused at the point enclosed by circle D in FIG. 4. FIG. 6 is a graph showing the results of the second computer simulation. The vertical axis indicates the tensile stress and the horizontal axis indicates H2/H1.

The graph of FIG. 6 shows that the tensile stress decreases with increasing H2/H1. In other words, wire breakage becomes less likely to occur in the inductors L1 and L2 as H2/H1 increases further. The graph thus shows that it is preferable that the through hole H be filled with the low expansion portion 80 without an entrance of the bonding layer 24. Specifically, the graph shows that it is preferable that the low expansion portion 80 be disposed in the through hole H so that it adjoins the magnetic substrate 20b at the lower end portion of the through hole H and adjoins the bonding layer 24 at the upper end portion of the through hole H.

When H2/H1 is approximately 0.7, the second to sixth models have lower tensile stress as their bonding layers 24 have smaller coefficients X3 of linear expansion. When H2/H1 is approximately 0.9, the second to sixth models have substantially equal tensile stress regardless of their coefficients X3 of linear expansion. When H2/H1 is approximately 1.0, the second to sixth models have higher tensile stress as their bonding layers 24 have larger coefficients X3 of linear expansion. Specifically, the relationship between the coefficient X3 of linear expansion and the tensile stress when H2/H1 is approximately 0.7 is opposite to the relationship between the coefficient X3 of linear expansion and the tensile stress when H2/H1 is approximately 1.0. Thus, the graph shows that it is preferable that the bonding layer 24 have a larger coefficient X3 of linear expansion when the bonding layer 24 does not enter the through hole H (specifically, when H2/H1 is approximately 1.0). FIG. 6 shows that it is preferable that the coefficient X3 of linear expansion of the bonding layer 24 be equal to the coefficient X2 of linear expansion (approximately 36×10⁻⁶/° C.) of the insulating layers 26a to 26e.

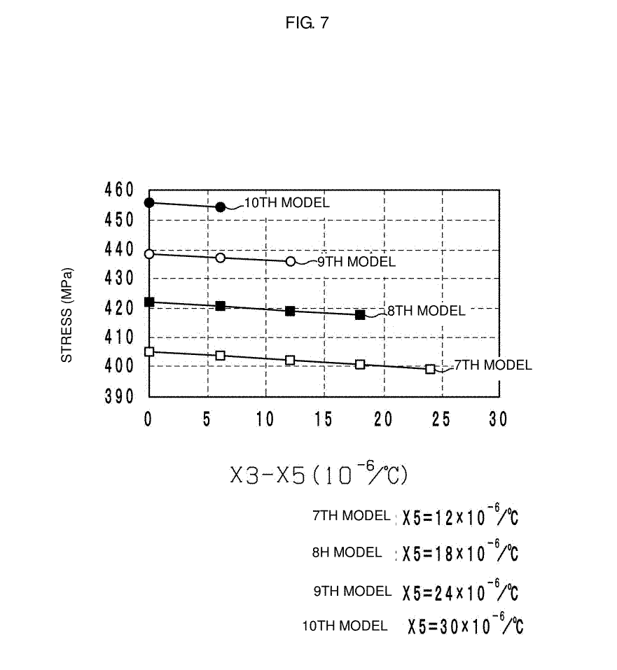

The second computer simulation was conducted in the state where the coefficient X5 of linear expansion of the low expansion portion 80 was fixed at approximately 12×10⁻⁶/° C. Then, the inventors of the application conducted the third computer simulation to confirm whether the results obtained from the third computer simulation in which the coefficient X5 of linear expansion is changed are the same as those obtained from the second computer simulation. In the third computer simulation, the inventors of the application created a model illustrated in FIG. 5. Here, H2/H1 was 1.0. The inventors of the application created seventh to tenth models, described below. The coefficient X5 of linear expansion of the low expansion portion of the seventh model is approximately 12×10⁻⁶/° C. The coefficient X5 of linear expansion of the low expansion portion of the eighth model is approximately 18×10⁻⁶/° C. The coefficient X5 of linear expansion of the low expansion portion of the ninth model is approximately 24×10⁻⁶/° C. The coefficient X5 of linear expansion of the low expansion portion of the tenth model is approximately 30×10⁻⁶/° C. The coefficients X1, X2, and X4 of linear expansion are the same as those used in the first computer simulation. The inventors of the application changed X3-X5 in the seventh to tenth models and caused the computer to calculate the tensile stress. The calculated tensile stress is the maximum tensile stress caused at the point enclosed by circle D in FIG. 4. FIG. 7 is a graph showing the results of the third computer simulation. The vertical axis indicates the tensile stress and the horizontal axis indicates X3-X5.

FIG. 7 shows that the tensile stress decreases as X3-X5 increases in either one of the seventh to tenth models. In other words, the tensile stress of any of the seventh to tenth models decreases as the coefficient X3 of linear expansion of the bonding layer 24 increases. Thus, the third computer simulation shows that a larger coefficient X3 of linear expansion is preferable when H2/H1 is approximately 1.0 regardless of the coefficient X5 of linear expansion.

### First Modified Example

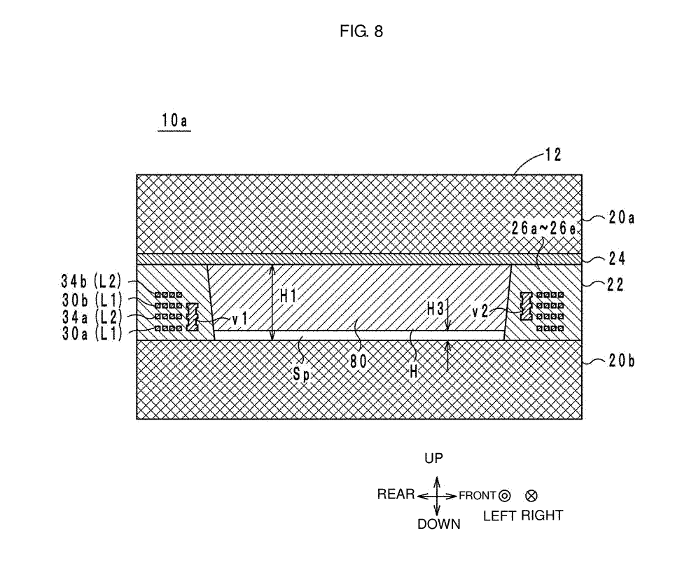

Referring now to the drawings, an electronic component 10a according to a first modified example is described below. FIG. 8 is a sectional view of the structure of the electronic component 10a. The external perspective view of the electronic component 10a is the same as the external perspective view of the electronic component 10 illustrated in FIG. 1. FIG. 8 is a sectional view of the structure taken along line 1-1 in FIG. 1.

The electronic component 10a is different from the electronic component 10 in that it includes a gap portion Sp. The electronic component 10a is described below mainly focusing on this difference.

When viewed from above, the gap portion Sp is disposed at a portion in the laminated body 22 that overlaps the low expansion portion 80 and that adjoins the low expansion portion 80 and the magnetic substrate 20b. More specifically, a portion around the lower end portion of the through hole H is not filled with the low expansion portion 80. Thus, the gap portion Sp is formed near the lower end of the through hole H. The undersurface of the low expansion portion 80 faces the top surface of the magnetic substrate 20b with the gap portion Sp interposed therebetween.

Other portions of the electronic component 10a are the same as those of the electronic component 10 and thus are not described here.

Examples of a method for forming the gap portion Sp include an adjustment of resin viscosity or an adjustment of the speed of squeegeeing or the number of times of squeegeeing performed to fill the through hole H with resin by screen printing. More specifically, the low expansion portion 80 of the electronic component 10a may be made of a resin having higher viscosity than the viscosity of the resin from which the low expansion portion 80 of the electronic component 10 is made. An example of how to increase the resin viscosity is to increase an amount of a silica filler that is to be added to the resin. Alternatively, a gap portion Sp is more likely to be formed by increasing the speed of squeegeeing since the amount of resin with which the through hole H is filled decreases by increasing the speed of squeegeeing. Instead, a gap portion Sp is more likely to be formed by reducing the number of times of squeegeeing since the amount of resin with which the through hole H is filled decreases by reducing the number of times of squeegeeing.

The electronic component 10a having the above-described configuration includes the low expansion portion 80 having a coefficient of linear expansion that is smaller than the coefficient of linear expansion of the insulating layers 26a to 26e. This configuration is thus capable of preventing an occurrence of wire breakage in the inductors L1 and L2 for the same reason as in the case of the electronic component 10.

The electronic component 10a is also capable of preventing an occurrence of wire breakage in the inductors L1 and L2 for the reason described below. More specifically, the gap portion Sp contains purely air. The gap portion Sp thus hardly ever expands when the electronic component 10a is heated. On the other hand, the insulating layers around the gap portion Sp expand and compress the gap portion Sp. The gap portion Sp thus allows the insulating layers to be freely deformed, so that the tensile stress caused in the insulating layers around the gap portion Sp decreases. Consequently, the electronic component 10a reduces the tensile stress exerted on the inductors L1 and L2 and prevents an occurrence of wire breakage in the inductors L1 and L2.

The electronic component 10a is also capable of preventing an occurrence of wire breakage in the inductors L1 and L2 for the reason described below. The electronic component is used for comparison to describe the effect of the electronic component 10a. More specifically, the second computer simulation and the third computer simulation have revealed that the tensile stress decreases when the coefficient X3 of linear expansion of the bonding layer 24 increases. This is because the tensile stress of portions of the insulating layers near the bonding layer 24 decreases due to the bonding layer 24 having a high coefficient X3 of linear expansion. In the electronic component 10, the bonding layer 24 is disposed between the magnetic substrate 20a and the top surface of the laminated body 22. The coefficient X3 of linear expansion of the bonding layer 24 is higher than the coefficient X5 of linear expansion of the low expansion portion 80. Thus, in the electronic component 10, the tensile stress near the upper end portion of the low expansion portion 80 is smaller than the tensile stress near the lower end portion of the low expansion portion 80.

The electronic component 10a thus has the gap portion Sp near the lower end of the through hole H, which is left hollow without being occupied by the low expansion portion 80. This gap portion Sp allows stress that occurs in portions of the insulating layers located around the lower end portion of the through hole H to be discharged thereto, so that the stress exerted to portions around the interlayer connection conductors v1 and v2 decreases. This configuration is thus capable of preventing an occurrence of wire breakage in the inductors L1 and L2.

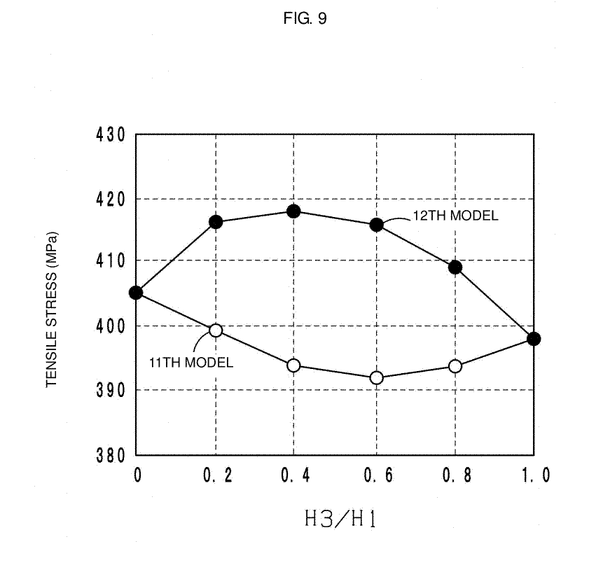

The inventors of the application conducted a fourth computer simulation, described below, to further clarify the effects of the electronic component 10a. More specifically, the inventors of the application created eleventh and twelfth models. The eleventh model has a structure illustrated in FIG. 8. In the eleventh model, the gap portion gradually widens upward from the side near the magnetic substrate 20b. On the other hand, in the twelfth model, the gap portion is disposed near the magnetic substrate 20a (at an upper portion). In the twelfth model, the gap portion gradually widens downward from the side near the magnetic substrate 20a. The eleventh model is a model according to an embodiment, whereas the twelfth model is a model according to a comparative example. In the eleventh model and the twelfth model, the height of the laminated body 22 is defined as a height H1 and the height of the gap portion Sp in the vertical direction is defined as a height H3. The inventors of the application changed H3/H1 in the eleventh and twelfth models and caused a computer to calculate the stress. The calculated stress is the maximum stress caused at the point enclosed by circle D in FIG. 4. FIG. 9 is a graph showing the results of the fourth computer simulation. The vertical axis indicates the tensile stress and the horizontal axis indicates H3/H1. The simulation conditions of the fourth computer simulation are the same as the simulation conditions of the first computer simulation.

FIG. 9 shows that the eleventh model has lower tensile stress than the twelfth model. Thus, the fourth computer simulation shows that the gap portion Sp is preferably disposed near the lower end of the through hole H and that the stress may increase further than in the case where the gap portion Sp is not disposed if the gap portion Sp is disposed near the upper end portion of the through hole H.

Then, the inventors of the application conducted a fifth computer simulation. The inventors of the application created 13th to 17th models in the fifth computer simulation. The 13th to 16th models have a structure illustrated in FIG. 8. The 17th model has a configuration that does not include the low expansion portion 80 and in which the coefficient X2 of linear expansion of the insulating layers 26a to 26e is equal to the coefficient of linear expansion of a portion corresponding to the low expansion portion. The coefficient X5 of linear expansion of the low expansion portion 80 in the 13th model is approximately 12×10⁻⁶/° C. The coefficient X5 of linear expansion of the low expansion portion 80 in the 14th model is approximately 18×10⁻⁶/° C. The coefficient X5 of linear expansion of the low expansion portion 80 in the 15th model is approximately 24×10⁻⁶/° C. The coefficient X5 of linear expansion of the low expansion portion 80 in the 16th model is approximately 30×10⁻⁶/° C. The coefficient of linear expansion of the portion corresponding to the low expansion portion in the 17th model is approximately 36×10⁻⁶/° C. The coefficients X1 to X4 of linear expansion are the same as those used in the first computer simulation.

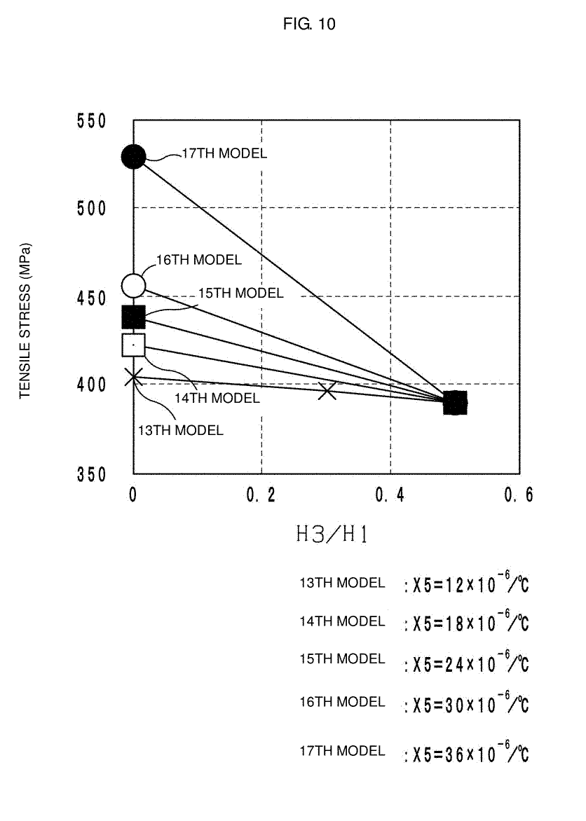

The inventors of the application changed H3/H1 in the 13th to 17th models and caused a computer to calculate the stress. The calculated stress is the maximum stress caused at the point enclosed by circle D in FIG. 4. FIG. 10 is a graph showing the results of the fifth computer simulation. The vertical axis indicates the tensile stress and the horizontal axis indicates H3/H1.

The graph of FIG. 10 shows that the tensile stress decreases as the coefficient X5 of linear expansion of the low expansion portion 80 decreases. In other words, the graph shows that an occurrence of wire breakage in the inductors L1 and L2 is prevented further efficiently as the coefficient X5 of linear expansion of the low expansion portion 80 decreases.

The graph also shows that the tensile stress decreases as H3/H1 increases. Specifically, the graph shows that an occurrence of wire breakage in the inductors L1 and L2 is prevented further efficiently as the gap portion Sp increases. However, when H3/H1 is approximately 0.5, the 13th to 17th models had substantially the same tensile stress regardless of the coefficient X5 of linear expansion. Specifically, the tensile stress that occurs in the 13th to 16th models was substantially equal to the tensile stress that occurs in the 17th model. The 13th to 16th models each have the low expansion portion 80 and the gap portion Sp. In other words, the 13th to 16th models have the structure of the electronic component 10a. In the 17th model, on the other hand, the coefficient X5 of linear expansion is equal to the coefficient X2 of linear expansion. The 17th model has the gap portion Sp instead of the low expansion portion 80. In other words, the 17th model has a structure different from the structure of the electronic component 10a. Thus, the electronic component 10a exerts an effect of reducing the tensile stress attributable to the decrease of the coefficient X5 of linear expansion of the low expansion portion 80 when H3/H1 is less than approximately 0.5. Thus, H3/H1 is preferably less than 0.5 in the electronic component 10a.

When H3/H1 exceeds 0.5, the strength of the electronic component 10a may decrease or the inductor conductor layers 30a, 30b, 34a, and 34b may be distorted. Thus, H3/H1 is preferably less than 0.5. However, as is clear from the graph in FIG. 9, the tensile stress that occurs in the eleventh model when H3/H1 falls within the range of approximately 0.4 to 0.8 is smaller than the tensile stress that occurs in the eleventh model when H3/H1 is approximately 1.0. Specifically, from the stress reduction point of view, H3/H1 may fall within the range of approximately 0.4 to 0.8.

### Second Modified Example

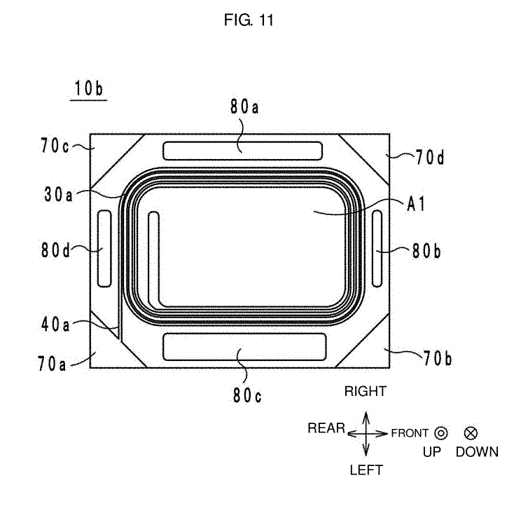

Referring now to the drawings, an electronic component 10b according to a second modified example is described. FIG. 11 is a perspective view of the electronic component 10b viewed from above. FIG. 11 illustrates an inductor conductor layer 30a and low expansion portions 80a to 80d.

The electronic component 10b is different from the electronic component 10 in that it includes the low expansion portions 80a to 80d instead of the low expansion portion 80. The electronic component 10b is described below mainly focusing on this difference.

The low expansion portions 80a to 80d are made of a material that is the same as the material of the low expansion portion 80 and have a coefficient X5 of linear expansion. The low expansion portions 80a to 80d are located on the outer sides of the inductor conductor layers 30a, 30b, 34a, and 34b (FIG. 11 only illustrates the inductor conductor layer 30a). The low expansion portions 80a to 80d extend through the insulating layers 26a to 26e in the vertical direction. When viewed from above, the low expansion portion 80a is located on the right side of the inductor conductor layers 30a, 30b, 34a, and 34b. When viewed from above, the low expansion portion 80b is located on the front side of the inductor conductor layers 30a, 30b, 34a, and 34b. When viewed from above, the low expansion portion 80c is located on the left side of the inductor conductor layers 30a, 30b, 34a, and 34b. When viewed from above, the low expansion portion 80d is located on the rear side of the inductor conductor layers 30a, 30b, 34a, and 34b. However, the low expansion portions 80a to 80d are not exposed to the outside from the front surface, the rear surface, the right surface, and the left surface of the laminated body 22.

Other components of the electronic component 10b are the same as those of the electronic component 10 and are thus not described.

Similarly to the electronic component 10, the electronic component 10b having the above-described configuration is capable of preventing an occurrence of wire breakage in the inductors L1 and L2. More specifically, the electronic component 10b includes the low expansion portions 80a to 80d, at least part of which is embedded in the laminated body 22. The coefficient x5 of linear expansion of the insulating resin from which the low expansion portions 80a to 80d are made is lower than the coefficient x2 of linear expansion of the insulating resin of the insulating layers 26a to 26e. In addition, the low expansion portions 80a to 80d are made of a material in which a silica filler is mixed into the insulating resin. Thus, the coefficient X5 of linear expansion of the low expansion portions 80a to 80d is lower than the coefficient x5 of linear expansion of the insulating resin. The coefficient X5 of linear expansion of the low expansion portions 80a to 80d is thus significantly lower than the coefficient X2 of linear expansion of the insulating layers 26a to 26e. Thus, when the electronic component 10b is heated, the low expansion portions 80a to 80d expand to a smaller extent than the extent to which the insulating layers 26a to 26e expand. The stress caused by the expansion of the insulating layers 26a to 26e is thus discharged toward the low expansion portions 80a to 80d. In this manner, the tensile stress exerted on the inductors L1 and L2 decreases, so that an occurrence of wire breakage in the inductors L1 and L2 is prevented.

The electronic component 10b is also capable of more effectively preventing an occurrence of wire breakage on the outer periphery of the inductors L1 and L2 for the reason described below. More specifically, in the electronic component 10b, the presence of the low expansion portions 80a to 80d prevents the portions of the insulating layers 26a to 26e located adjacent to the low expansion portions 80a to 80d from expanding to a larger extent than portions of the insulating layers 26a to 26e located further away from the low expansion portions 80a to 80d. Thus, in view of preventing an occurrence of wire breakage in the inductors L1 and L2, it is preferable that the inductors L1 and L2 be located adjacent to the low expansion portions 80a to 80d.

Thus, the inductor conductor layers 30a, 30b, 34a, and 34b each form a substantially spiral shape that winds clockwise, when viewed from above. The low expansion portion 80a is located on the right side of the inductor conductor layers 30a, 30b, 34a, and 34b, when viewed from above. The low expansion portion 80b is located on the front side of the inductor conductor layers 30a, 30b, 34a, and 34b, when viewed from above. The low expansion portion 80c is located on the left side of the inductor conductor layers 30a, 30b, 34a, and 34b, when viewed from above. The low expansion portion 80d is located on the rear side of the inductor conductor layers 30a, 30b, 34a, and 34b, when viewed from above. Thus, the low expansion portions 80a to 80d are located around the inductor conductor layers 30a, 30b, 34a, and 34b, when viewed from above. In other words, a large part of the inductor conductor layers 30a, 30b, 34a, and 34b is located adjacent to the low expansion portions 80a to 80d. This configuration thus more effectively prevents an occurrence of wire breakage in the inductors L1 and L2.

### Third Modified Example

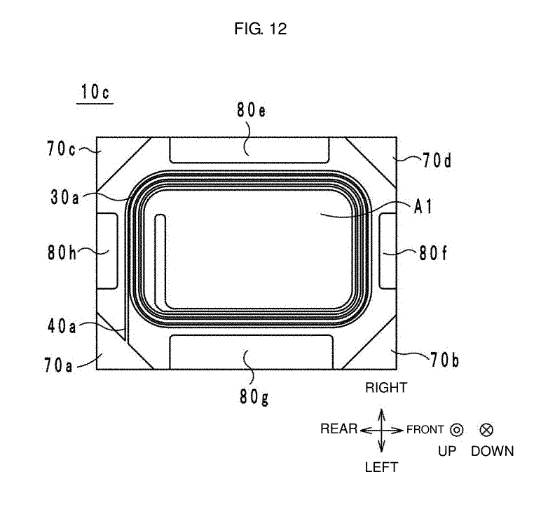

An electronic component 10c according to a third modified example is described below with reference to the drawings. FIG. 12 is a perspective view of the electronic component 10c viewed from above. FIG. 12 illustrates an inductor conductor layer 30a and low expansion portions 80e to 80h.

The electronic component 10c is different from the electronic component 10b in that it includes low expansion portions 80e to 80h instead of the low expansion portions 80a to 80d. The electronic component 10c is described below mainly focusing on this difference.

The low expansion portions 80e to 80h are made of a material the same as the material of the low expansion portion 80. The low expansion portions 80e to 80h have a coefficient X5 of linear expansion. The low expansion portions 80e to 80h are located on the outer sides of the inductor conductor layers 30a, 30b, 34a, and 34b (FIG. 12 only illustrates the inductor conductor layer 30a). The low expansion portions 80e to 80h extend through the insulating layers 26a to 26e in the vertical direction. When viewed from above, the low expansion portion 80e is located on the right side of the inductor conductor layers 30a, 30b, 34a, and 34b. When viewed from above, the low expansion portion 80f is located on the front side of the inductor conductor layers 30a, 30b, 34a, and 34b. When viewed from above, the low expansion portion 80g is located on the left side of the inductor conductor layers 30a, 30b, 34a, and 34b. When viewed from above, the low expansion portion 80h is located on the rear side of the inductor conductor layers 30a, 30b, 34a, and 34b. Here, the low expansion portions 80e to 80h are exposed from the right surface, the front surface, the left surface, and the rear surface of the laminated body 22.

Other components of the electronic component 10c are the same as those of the electronic component 10b and are thus not described here.

The electronic component 10c having the above configuration is capable of exerting the same effect as the electronic component 10b.

### Fourth Modified Example

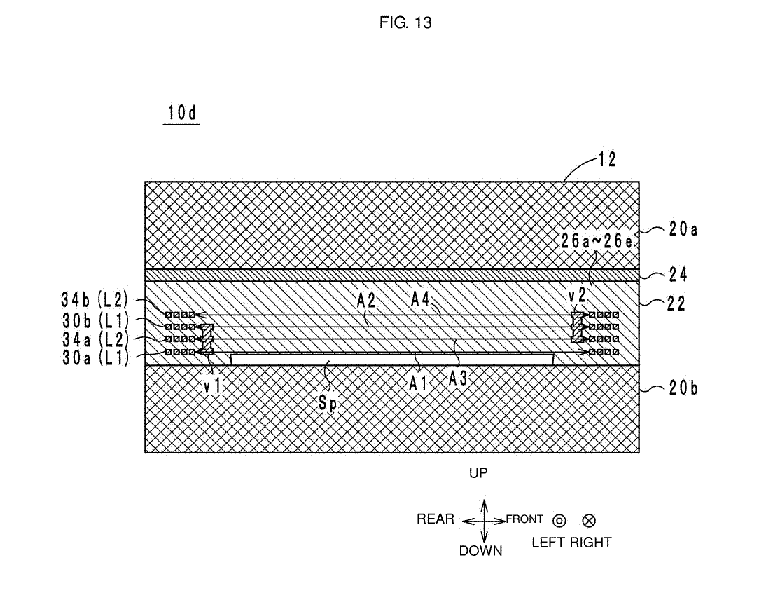

The configuration of an electronic component 10d according to a fourth modified example is described with reference to the drawings. FIG. 13 is a sectional view of the structure of the electronic component 10d. The external perspective view of the electronic component 10d is the same as the external perspective view of the electronic component 10 and FIG. 1 is thus referred below. FIG. 13 is a sectional view of the structure taken along line 1-1 of FIG. 1.

The electronic component 10d is different from the electronic component 10a in that it does not include the low expansion portion 80. The electronic component 10d is described below mainly focusing on this difference.

In the electronic component 10d, the gap portion Sp is disposed in the laminated body 22 at a position inside the areas A1 to A4, when viewed from above, and adjoins the magnetic substrate 20b. Here, instead of the low expansion portion 80, the insulating layers 26a to 26e are disposed above the gap portion Sp.

Other components of the electronic component 10d are the same as those of the electronic component 10a and thus are not described here.

Similarly to the electronic component 10a, the electronic component 10d having the above-described configuration also prevents an occurrence of wire breakage in the inductors L1 and L2. More specifically, the gap portion Sp contains purely air. The gap portion Sp thus hardly ever expands when the electronic component 10a is heated. On the other hand, the insulating layers around the gap portion Sp expand and compress the gap portion Sp. The gap portion Sp thus allows the insulating layers to be freely deformed, so that the tensile stress caused in the insulating layers around the gap portion Sp decreases. Consequently, the electronic component 10d reduces the tensile stress exerted on the inductors L1 and L2 and prevents an occurrence of wire breakage in the inductors L1 and L2.

Here, the 17th model has a structure of the electronic component 10d. FIG. 10 shows that the 17th model also reduces the tensile stress with the presence of the gap portion Sp. FIG. 10 also shows that the 17th model reduces the tensile stress with an increase of H3/H1.

From the stress reduction point of view, we have described that H3/H1 may fall within the range of approximately 0.4 to 0.8, as is clear from the graph of FIG. 9, in the eleventh model including the low expansion portion 80. Presumably, the electronic component 10d that does not include the low expansion portion 80 also has the same characteristics as the eleventh model. Thus, from the stress reduction point of view, it is preferable in the electronic component 10d that H3/H1 fall within the range of approximately 0.4 to 0.8. When H3/H1 exceeds 0.5, the strength of the electronic component 10d may decrease or the inductor conductor layers 30a, 30b, 34a, and 34b may be distorted. Thus, H3/H1 is preferably less than 0.5.

Similarly to the electronic component 10a, the electronic component 10d is also capable of preventing an occurrence of wire breakage in the inductors L1 and L2 for the reason described below. More specifically, in the electronic component 10d, the bonding layer 24 adjoins the top surface of the laminated body 22. The bonding layer 24 has a coefficient X3 of linear expansion, which is relatively large. Thus, the bonding layer 24 reduces the stress at a portion adjacent to the top surface of the laminated body 22. On the other hand, the magnetic substrate 20b adjoins the undersurface of the laminated body 22. The magnetic substrate 20b has a coefficient X1 of linear expansion, which is relatively small. Thus, the stress is less likely to decrease at a portion adjacent to the undersurface of the laminated body 22. Thus, in the electronic component 10d, the gap portion Sp is disposed so as to adjoin the magnetic substrate 20b. This configuration allows reduction of the stress that occurs in the insulating layers at a portion adjacent to the undersurface of the laminated body 22. This configuration is thus capable of preventing an occurrence of wire breakage in the inductors L1 and L2.

### Fifth Modified Example

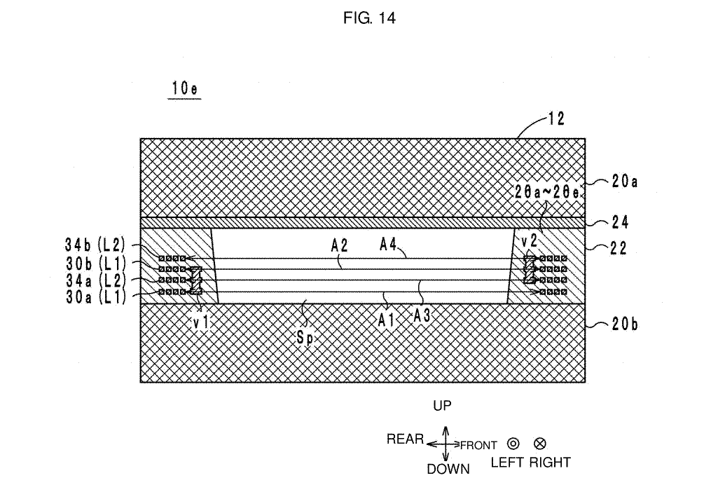

The configuration of an electronic component 10e according to a fifth modified example is described below with reference to the drawings. FIG. 14 is a sectional view of the structure of the electronic component 10e. The external perspective view of the electronic component 10e is the same as the external perspective view of the electronic component 10 and FIG. 1 is thus referred below. FIG. 14 is a sectional view of the structure taken along line 1-1 of FIG. 1.

The electronic component 10e is different from the electronic component 10d in terms of the structure of the gap portion Sp. The electronic component 10e is described below mainly focusing on this difference.

In the electronic component 10e, the gap portion Sp extends in the vertical direction so as to adjoin the bonding layer 24 and the magnetic substrate 20b. Thus, the gap portion Sp extends through the areas A1 to A4 in the vertical direction.

Other components of the electronic component 10e are the same as those of the electronic component 10d and thus are not described here.

The electronic component 10e having the above-described configuration also prevents an occurrence of wire breakage in the inductors L1 and L2 for the same reason as in the case of the electronic component 10d.

### Other Embodiments

Electronic components according to some embodiments of the disclosure are not limited to the electronic components 10 and 10a to 10e and can be modified within the scope of the gist of the disclosure.

The configurations of the electronic components 10 and 10a to 10e may be combined appropriately. Particularly, a combination of the low expansion portion 80 of the electronic component 10 and the low expansion portions 80a to 80h of the electronic components 10b and 10c is desirable from the point of view of reduction of stress that occurs on the inner side and the outer side of the inductors L1 and L2.

In the electronic component 10d or 10e, the gap portion Sp may be disposed on the outer side of the inductor conductor layers 30a, 30b, 34a, and 34b. Preferably, the gap portion Sp and the low expansion portion 80 are located adjacent to a portion at which a large stress occurs.

The inductor L1 is formed by connecting the substantially spiral inductor conductor layer 30a and the substantially spiral inductor conductor layer 30b together with the interlayer connection conductor v1 interposed therebetween. The configuration of the inductor L1, however, is not limited to this. The inductor L1 may form a substantially helical shape in which multiple inductor conductor layers each having a length corresponding to one turn are connected in series with the interlayer connection conductor interposed therebetween.

Alternatively, the inductor L1 may be formed only of one inductor conductor layer without including the interlayer connection conductor. Alternatively, the inductor conductor layers 30a and 30b may have a shape of, for example, a substantially straight line, instead of a winding shape. Similarly to the inductor L1, the configuration of the inductor L2 is not limited to the one in which the substantially spiral inductor conductor layer 34a and the substantially spiral inductor conductor layer 34b are connected together with the interlayer connection conductor v2 interposed therebetween. Here, the substantially spiral shape is a two-dimensional curve and the substantially helical shape is a three-dimensional curve.

The inductors L1 and L2 do not have to form a common mode choke coil. In this case, the inductors L1 and L2 may form a transformer or a balun, or may be two inductors electrically connected in parallel.

Each of the low expansion portions 80 and 80a to 80h adjoins both magnetic substrates 20a and 20b or the magnetic substrate 20a, but does not have to adjoin both magnetic substrates 20a and 20b.

Instead of the magnetic substrates 20a and 20b, non-magnetic substrates may be disposed.

Although the low expansion portions 80 and 80a to 80h are described as being non-magnetic, they may be magnetic. When the low expansion portions 80 and 80a to 80h are non-magnetic, the low expansion portions 80 and 80a to 80h have a low eddy current loss, so that a high Q-value can be obtained also in a high frequency range. On the other hand, when the low expansion portions 80 and 80a to 80h are magnetic, the inductors L1 and L2 have high magnetic permeability, so that the inductors L1 and L2 have a high inductance value.

Each of the electronic components 10 and 10a to 10d includes two inductors L1 and L2. However, each of the electronic components 10 and 10a to 10d may include one inductor or three inductors or more. Each of the electronic components 10 and 10a to 10d may include a circuit element (such as a capacitor) other than an inductor.

Each of the electronic components 10 and 10a to 10c does not necessarily have to include the magnetic substrates 20a and 20b or the bonding layer 24. Each of the electronic components 10d and 10e does not necessarily have to include the magnetic substrate 20a or the bonding layer 24.

The inductor conductor layers 30a, 30b, 34a, and 34b, the exit conductor layers 40a, 40b, 44a, and 44b, the connection conductors 70a to 70d, and the interlayer connection conductors v1 and v2 may be formed by any of plating (subtractive, semi-additive, or full additive), deposition, and coating.

The inductor conductor layer 30a may be disposed on the top surface of the magnetic substrate 20b instead of the top surface of the insulating layer 26e.

In each of the electronic components 10 and 10a to 10c, the insulating resin (an example of the first resin) used as the material of the insulating layers 26a to 26e and the insulating resin (an example of the second resin) used as the material of the low expansion portion 80 may be the same. In this case, however, the low expansion portion 80 is magnetic. Specifically, the low expansion portion 80 is made of a material in which magnetic powder is mixed into an insulating resin the same as the insulating resin used as the material of the insulating layers 26a to 26e.

As described thus far, each embodiment of the present disclosure is useful as an electronic component and, particularly, efficient in prevention of an occurrence of wire breakage in an inductor.

While some embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An electronic component comprising:
a body that includes a laminated body including a plurality of insulating layers laminated in a lamination direction, the insulating layers containing a first resin as a material;
a first inductor including a first inductor conductor layer that adjoins one of the insulating layers; and
a low expansion portion having a coefficient of linear expansion lower than a coefficient of linear expansion of the plurality of insulating layers, the low expansion portion containing a second resin as a material, and at least part of the low expansion portion being embedded in the laminated body,
wherein the second resin has a coefficient of linear expansion that is lower than a coefficient of linear expansion of the first resin.

2. An electronic component comprising:
a body that includes a laminated body including a plurality of insulating layers laminated in a lamination direction, the insulating layers containing a first resin as a material;
a first inductor including a first inductor conductor layer that adjoins one of the insulating layers; and
a low expansion portion having a coefficient of linear expansion lower than a coefficient of linear expansion of the plurality of insulating layers, the low expansion portion containing a second resin as a material, and at least part of the low expansion portion being embedded in the laminated body,
wherein the low expansion portion is non-magnetic.

3. The electronic component according to claim 1, wherein the plurality of insulating layers and the low expansion portion are non-magnetic.

4. The electronic component according to claim 1, wherein the first inductor winds in a predetermined direction when viewed in the lamination direction.

5. The electronic component according to claim 4, wherein the low expansion portion is located within an area surrounded by the first inductor.

6. The electronic component according to claim 4, further comprising:
a second inductor that includes a second inductor conductor layer that adjoins one of the insulating layers,
wherein the second inductor winds in the predetermined direction when viewed in the lamination direction, and
wherein an area surrounded by the first inductor overlaps an area surrounded by the second inductor when viewed in the lamination direction.

7. The electronic component according to claim 1, further comprising:
a second inductor that includes a second inductor conductor layer that adjoins one of the insulating layers,
wherein the low expansion portion is located within an area surrounded by the second inductor when viewed in the lamination direction.

8. The electronic component according to claim 1,
wherein the laminated body has a first main surface on a first side in the lamination direction,
wherein the body further includes a first substrate that has a coefficient of linear expansion lower than the coefficient of linear expansion of the plurality of insulating layers, the first substrate adjoining the first main surface.

9. The electronic component according to claim 8, wherein the laminated body has a gap portion that overlaps the low expansion portion when viewed in the lamination direction and that adjoins the low expansion portion and the first substrate.

10. The electronic component according to claim 9, wherein a ratio of a height of the gap portion in the lamination direction to a height of the laminated body in the lamination direction falls within 0.4 to 0.8.

11. The electronic component according to claim 9, wherein a ratio of a height of the gap portion in the lamination direction to a height of the laminated body in the lamination direction is lower than 0.5.

12. The electronic component according to claim 8,
wherein the laminated body further has a second main surface on a second side in the lamination direction, and
wherein the body further includes
a second substrate that has a coefficient of linear expansion lower than the coefficient of linear expansion of the plurality of insulating layers, and
a bonding layer that has a coefficient of linear expansion higher than or equal to the coefficient of linear expansion of the low expansion portion, the bonding layer bonding the second substrate and the second main surface to each other.

13. The electronic component according to claim 12,
wherein the laminated body has a through hole that extends through the laminated body in the lamination direction, and
wherein the low expansion portion is disposed in the through hole so as to adjoin the first substrate and the bonding layer.

14. An electronic component, comprising:
a body that includes a laminated body and a first substrate, the laminated body including a plurality of insulating layers laminated in a lamination direction, the insulating layers containing a resin as a material, the first substrate having a coefficient of linear expansion lower than a coefficient of linear expansion of the plurality of insulating layers, the first substrate adjoining a first main surface of the laminated body, the first main surface being located on a first side in the lamination direction; and
a first inductor that includes a first inductor conductor layer that adjoins one of the insulating layers,
wherein the laminated body has a gap portion that adjoins the first substrate.

15. The electronic component according to claim 14, wherein the plurality of insulating layers are non-magnetic.

16. The electronic component according to claim 14, wherein the first inductor winds in a predetermined direction when viewed in the lamination direction.

17. The electronic component according to claim 16, wherein the gap portion is located within an area surrounded by the first inductor when viewed in the lamination direction.

18. The electronic component according to claim 16, further comprising:
a second inductor that includes a second inductor conductor layer that adjoins one of the insulating layers,
wherein the second inductor winds in the predetermined direction when viewed in the lamination direction, and
wherein an area surrounded by the first inductor overlaps an area surrounded by the second inductor when viewed in the lamination direction.

19. The electronic component according to claim 14, further comprising:
a second inductor that includes a second inductor conductor layer that adjoins one of the insulating layers,
wherein the gap portion is located within an area surrounded by the second inductor when viewed in the lamination direction.

20. The electronic component according to claim 14,
wherein the laminated body further has a second main surface on a second side in the lamination direction, and
wherein the body further includes
a second substrate that has a coefficient of linear expansion lower than the coefficient of linear expansion of the plurality of insulating layers, and
a bonding layer that bonds the second substrate and the second main surface to each other.

21. The electronic component according to claim 14, wherein a ratio of a height of the gap portion in the lamination direction to a height of the laminated body in the lamination direction falls within 0.4 to 0.8.

22. The electronic component according to claim 14, wherein a ratio of a height of the gap portion in the lamination direction to a height of the laminated body in the lamination direction is lower than 0.5.

23. The electronic component according to claim 2, wherein the plurality of insulating layers and the low expansion portion are non-magnetic.

24. The electronic component according to claim 2, wherein the first inductor winds in a predetermined direction when viewed in the lamination direction.

25. The electronic component according to claim 24, wherein the low expansion portion is located within an area surrounded by the first inductor.

26. The electronic component according to claim 24, further comprising:
a second inductor that includes a second inductor conductor layer that adjoins one of the insulating layers,
wherein the second inductor winds in the predetermined direction when viewed in the lamination direction, and
wherein an area surrounded by the first inductor overlaps an area surrounded by the second inductor when viewed in the lamination direction.

27. The electronic component according to claim 2, further comprising:
a second inductor that includes a second inductor conductor layer that adjoins one of the insulating layers,
wherein the low expansion portion is located within an area surrounded by the second inductor when viewed in the lamination direction.

28. The electronic component according to claim 2,
wherein the laminated body has a first main surface on a first side in the lamination direction,
wherein the body further includes a first substrate that has a coefficient of linear expansion lower than the coefficient of linear expansion of the plurality of insulating layers, the first substrate adjoining the first main surface.

29. The electronic component according to claim 28, wherein the laminated body has a gap portion that overlaps the low expansion portion when viewed in the lamination direction and that adjoins the low expansion portion and the first substrate.

30. The electronic component according to claim 29, wherein a ratio of a height of the gap portion in the lamination direction to a height of the laminated body in the lamination direction falls within 0.4 to 0.8.

31. The electronic component according to claim 29, wherein a ratio of a height of the gap portion in the lamination direction to a height of the laminated body in the lamination direction is lower than 0.5.

32. The electronic component according to claim 28,
wherein the laminated body further has a second main surface on a second side in the lamination direction, and
wherein the body further includes
a second substrate that has a coefficient of linear expansion lower than the coefficient of linear expansion of the plurality of insulating layers, and
a bonding layer that has a coefficient of linear expansion higher than or equal to the coefficient of linear expansion of the low expansion portion, the bonding layer bonding the second substrate and the second main surface to each other.

33. The electronic component according to claim 32,
wherein the laminated body has a through hole that extends through the laminated body in the lamination direction, and
wherein the low expansion portion is disposed in the through hole so as to adjoin the first substrate and the bonding layer.
